(19) United States
(12) Patent Application Publication
(10) Pub. No.: US 2025/0063535 A1
(43) Pub. Date: Feb. 20, 2025

(54) POSITIONING REFERENCE SIGNAL MEASUREMENT PERIOD FOR USER EQUIPMENT IN INACTIVE STATE

(71) Applicant: QUALCOMM Incorporated, San Diego, CA (US)

(72) Inventors: Carlos CABRERA MERCADER, Cardiff, CA (US); Alexandros MANOLAKOS, Athens (GR); Sony AKKARAKARAN, Poway, CA (US); Sven FISCHER, Nuremberg (DE); Jae Ho RYU, San Diego, CA (US)

(21) Appl. No.: 18/723,197

(22) PCT Filed: Nov. 4, 2022
(86) PCT No.: PCT/US2022/079325

§ 371 Date: Jun. 21, 2024

(30) Foreign Application Priority Data
Jan. 7, 2022 (GR) 20220100013

(51) Int. Cl. H04W 64/00; H04L 5/00; H04W 8/22; H04W 36/08; H04W 68/02; H04W 76/28

(52) U.S. Cl. CPC H04W 64/00; H04L 5/0051; H04W 8/22; H04W 36/08; H04W 68/02; H04W 76/28

(57) ABSTRACT

Disclosed are techniques for wireless communication. In an aspect, a user equipment (UE) may determine a downlink (DL) positioning reference signal (PRS) measurement period for measuring and processing DL PRSs transmitted by a base station while the UE is in a radio resource control (RRC) INACTIVE state. While in the RRC INACTIVE state, the UE may measure and process DL PRSs during the DL PRS measurement period. In another aspect, a network entity may receive one or more parameters associated with a capability of a UE to measure and process DL PRSs while the UE is in a RRC INACTIVE state. Based on those parameters, the network entity may determine a DL PRS measurement period to be used by the UE while the UE is in the RRC INACTIVE state. The network entity may send, to the UE, information for determining the DL PRS measurement period.

### CROSS-REFERENCE TO RELATED APPLICATIONS

The present Application for Patent claims the benefit of GR application No. 20220100013, entitled “POSITIONING REFERENCE SIGNAL MEASUREMENT PERIOD FOR USER EQUIPMENT IN INACTIVE STATE”, filed Jan. 7, 2022, and is a national stage application, filed under 35 U.S.C. § 371, of International Patent Application No. PCT/US2022/079325, entitled, “METHODS AND APPARATUSES FOR DETERMINING POSITIONING REFERENCE SIGNAL MEASUREMENT PERIOD FOR USER EQUIPMENT IN INACTIVE STATE”, filed Nov. 4, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes determining a downlink (DL) positioning reference signal (PRS) measurement period for measuring and processing DL PRSs transmitted by a base station while the UE is in a radio resource control (RRC) INACTIVE state; and while in the RRC INACTIVE state, measuring and processing DL PRSs during the DL PRS measurement period.

In an aspect, a method of wireless communication performed by a network entity includes receiving, from a UE, a set of one or more parameters associated with a capability of the UE to measure and process DL PRSs while the UE is in a RRC INACTIVE state; and determining, based on the set of one or more parameters, a DL PRS measurement period for measuring and processing DL PRSs transmitted by a base station while the UE is in a RRC INACTIVE state; and sending, to the UE, information indicating the DL PRS measurement period.

In an aspect, a UE includes a memory; at least one transceiver; and at least one processor communicatively coupled to the memory and the at least one transceiver, the at least one processor configured to: determine a DL PRS measurement period for measuring and processing DL PRSs transmitted by a base station while the UE is in a RRC INACTIVE state; and while in the RRC INACTIVE state, measure and process DL PRSs during the DL PRS measurement period.

In an aspect, a network entity includes a memory; at least one transceiver; and at least one processor communicatively coupled to the memory and the at least one transceiver, the at least one processor configured to: receive, via the at least one transceiver, from a UE, a set of one or more parameters associated with a capability of the UE to measure and process DL PRSs while the UE is in a RRC INACTIVE state; and determine, based on the set of one or more parameters, a DL PRS measurement period for measuring and processing DL PRSs transmitted by a base station while the UE is in a RRC INACTIVE state; and send, via the at least one transceiver, to the UE, information for determining the DL PRS measurement period.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram of an example positioning reference signal (PRS) configuration for the PRS transmissions of a given base station, according to aspects of the disclosure.

FIG. 7 illustrates measuring and processing positioning reference signal (PRS) data during an active (e.g., connected) mode, according to aspects of the disclosure.

FIG. 8 illustrates the different radio resource control (RRC) states available in New Radio (NR), according to aspects of the disclosure.

FIGS. 9A to 9C illustrate example discontinuous reception (DRX) configurations, according to aspects of the disclosure.

FIG. 10 illustrates measuring and processing PRS data during RRC INACTIVE state, according to aspects of the disclosure.

FIG. 11 is a flowchart of an example process 1100 associated with positioning reference signal measurement period for user equipment in inactive state, according to aspects of the disclosure.

FIG. 12 is a flowchart of an example process 1200 associated with positioning reference signal measurement period for user equipment in inactive state, according to aspects of the disclosure.

### DETAILED DESCRIPTION

Disclosed are techniques for wireless communication. In an aspect, a user equipment (UE) may determine a downlink (DL) positioning reference signal (PRS) measurement period for measuring and processing DL PRSs transmitted by a base station while the UE is in a radio resource control (RRC) INACTIVE state. While in the RRC INACTIVE state, the UE may measure and process DL PRSs during the DL PRS measurement period. In another aspect, a network entity may receive one or more parameters associated with a capability of the UE to measure and process DL PRSs while the UE is in a RRC INACTIVE state. Based on those parameters, the network entity may determine a DL PRS measurement period to be used by the UE while the UE is in the RRC INACTIVE state. The network entity may send, to the UE, information for determining the DL PRS measurement period.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device.” a “subscriber terminal,” a “subscriber station,” a “user terminal” or “UT,” a “mobile device,” a “mobile terminal.” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

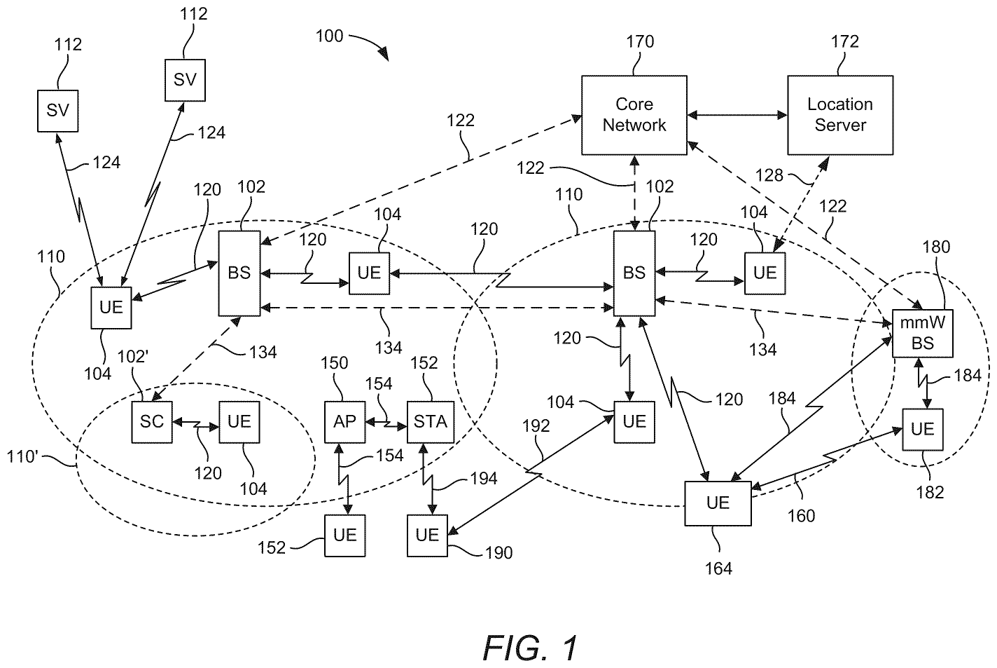

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mm W base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell.” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mm W base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (cV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases. UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

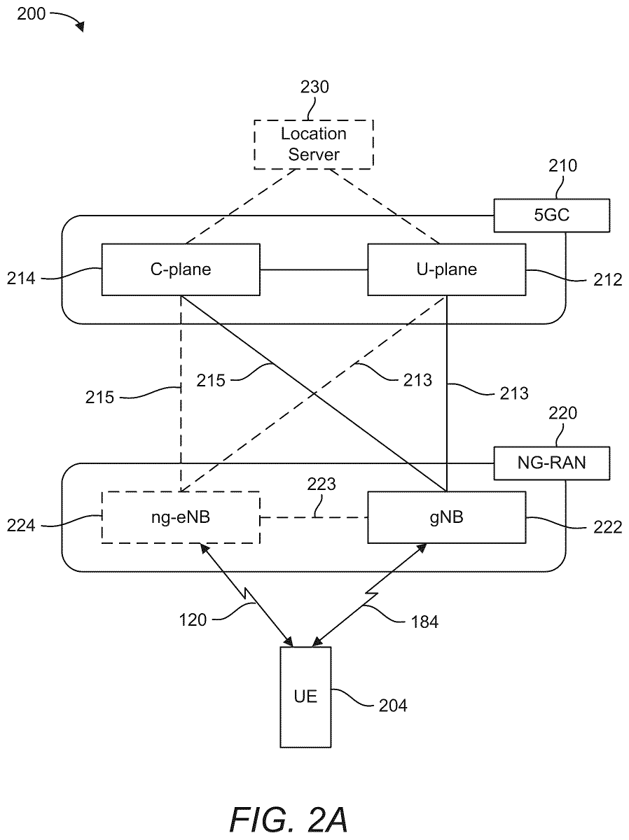

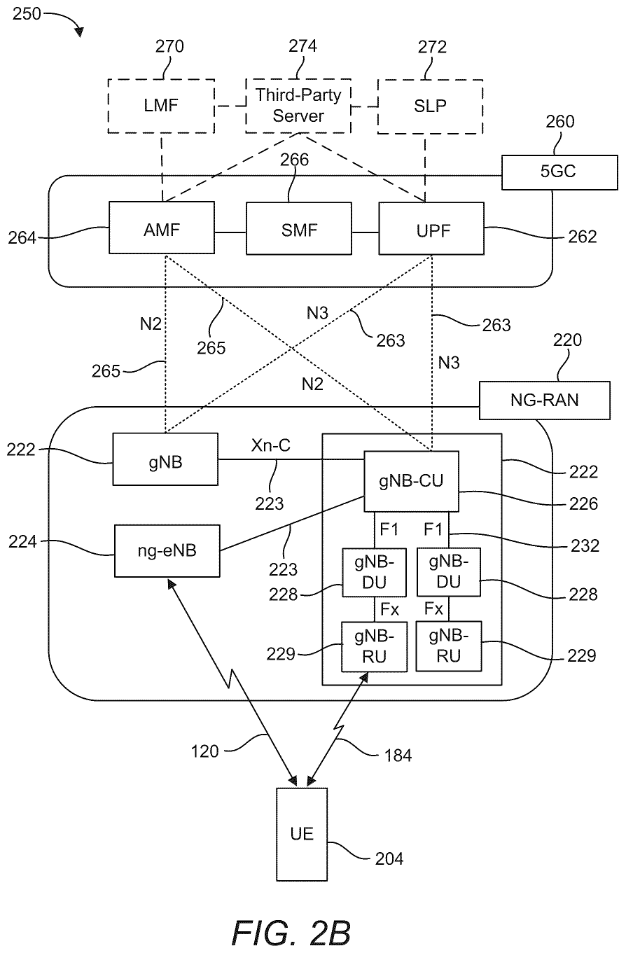

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-cNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

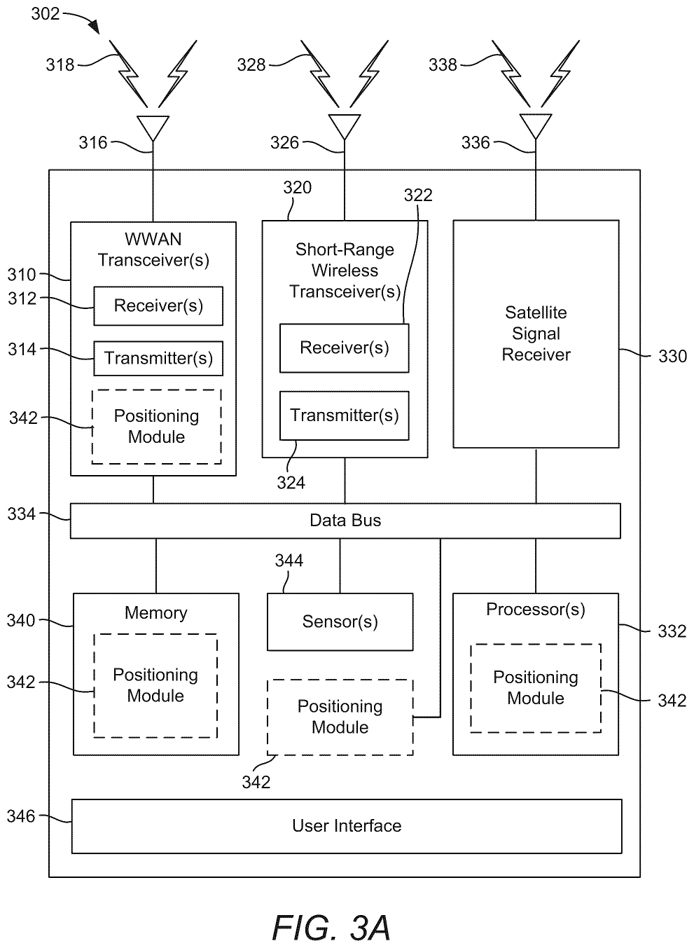

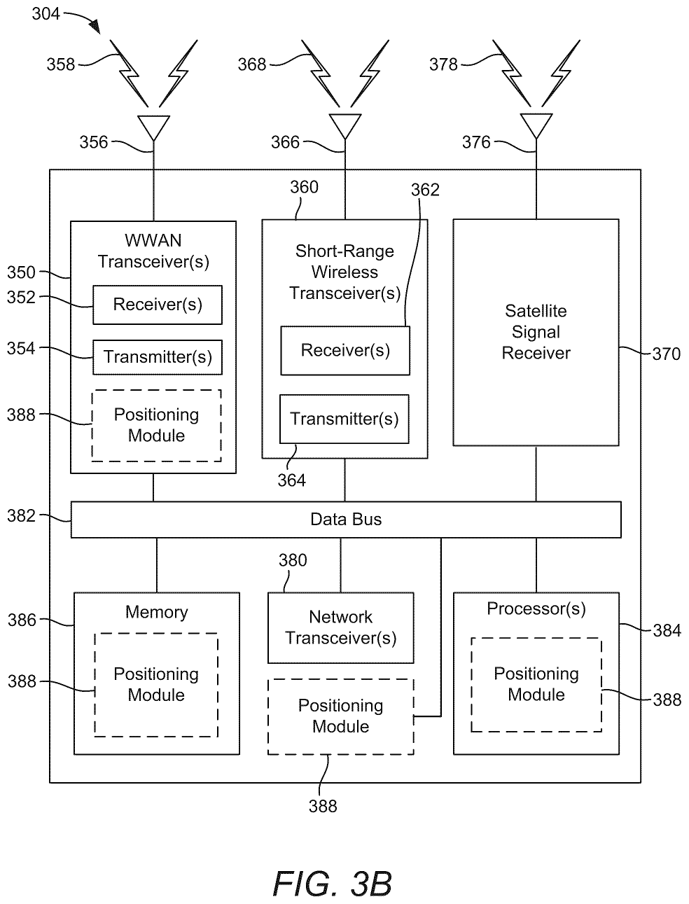

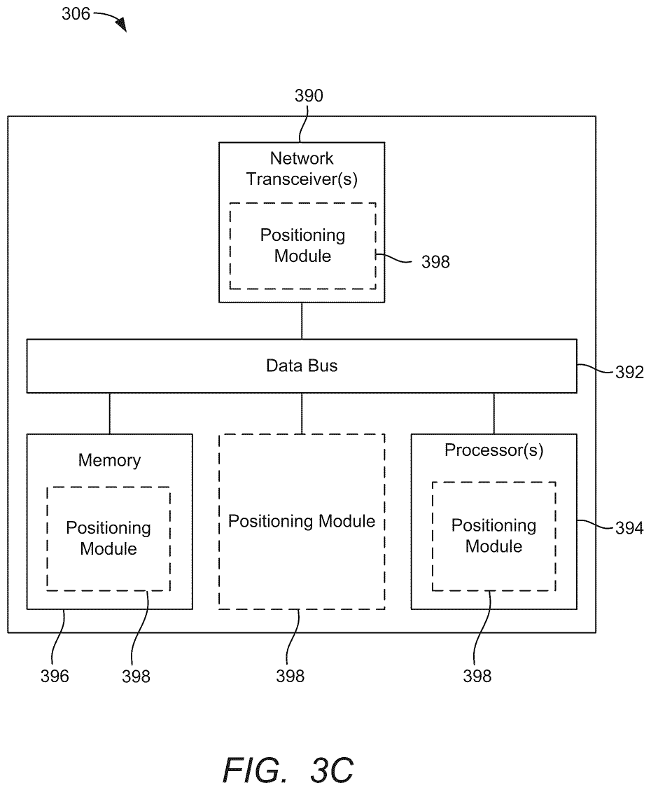

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbec®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals. Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning module 342, 388, and 398, respectively. The positioning module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning module 342, 388, and 398 may be external to the processors 332, 384, and 394 (e.g., part of a modem processing system, integrated with another processing system, etc.). Alternatively, the positioning module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning module 342, which may be, for example, part of the one or more WWAN transceivers 310, the memory 340, the one or more processors 332, or any combination thereof, or may be a standalone component. FIG. 3B illustrates possible locations of the positioning module 388, which may be, for example, part of the one or more WWAN transceivers 350, the memory 386, the one or more processors 384, or any combination thereof, or may be a standalone component. FIG. 3C illustrates possible locations of the positioning module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink. IP packets from the network entity 306 may be provided to the processor 384. The one or more processors 384 may implement functionality for an RRC layer, a packet data convergence protocol (PDCP) layer, a radio link control (RLC) layer, and a medium access control (MAC) laver. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK). M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

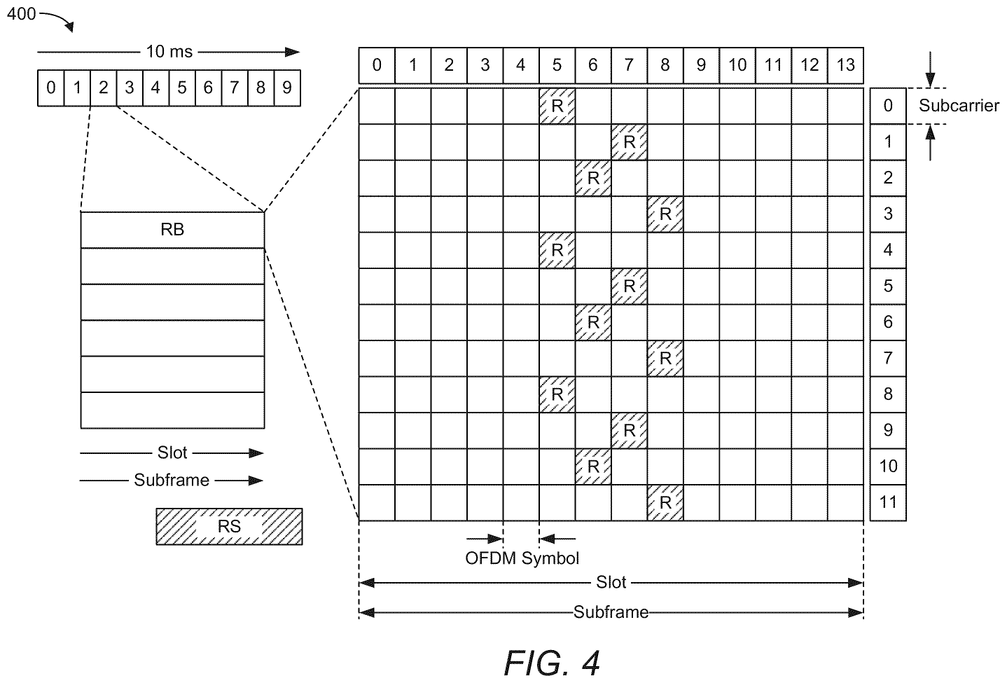

FIG. 4 is a diagram 400 illustrating an example frame structure, according to aspects of the disclosure. Various frame structures may be used to support downlink and uplink transmissions between network nodes (e.g., base stations and UEs). The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe. 20 slots per frame, the slot duration is 0.5 ms, the symbol duration is 33.3 μs, and the maximum nominal system bandwidth (in MHz) with a 4K FFT size is 100. For 60 KHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

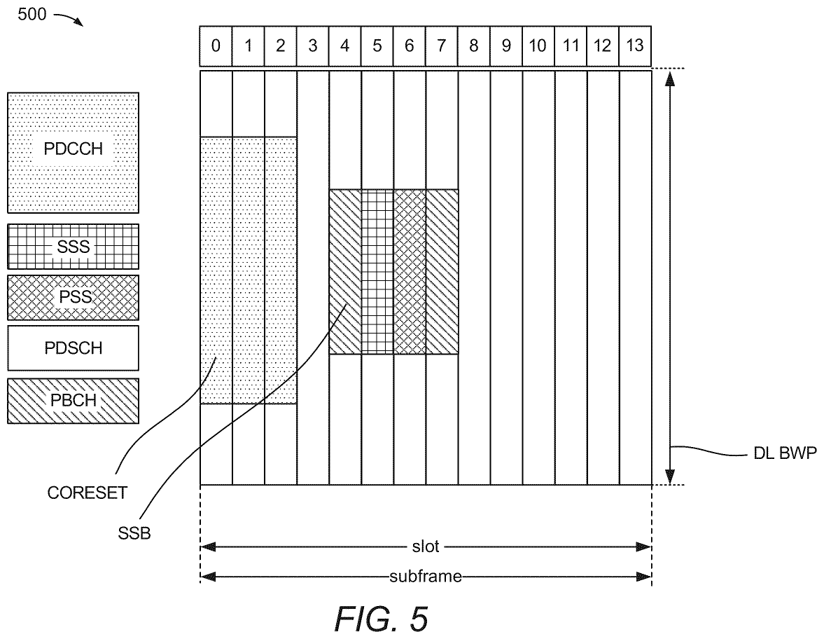

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

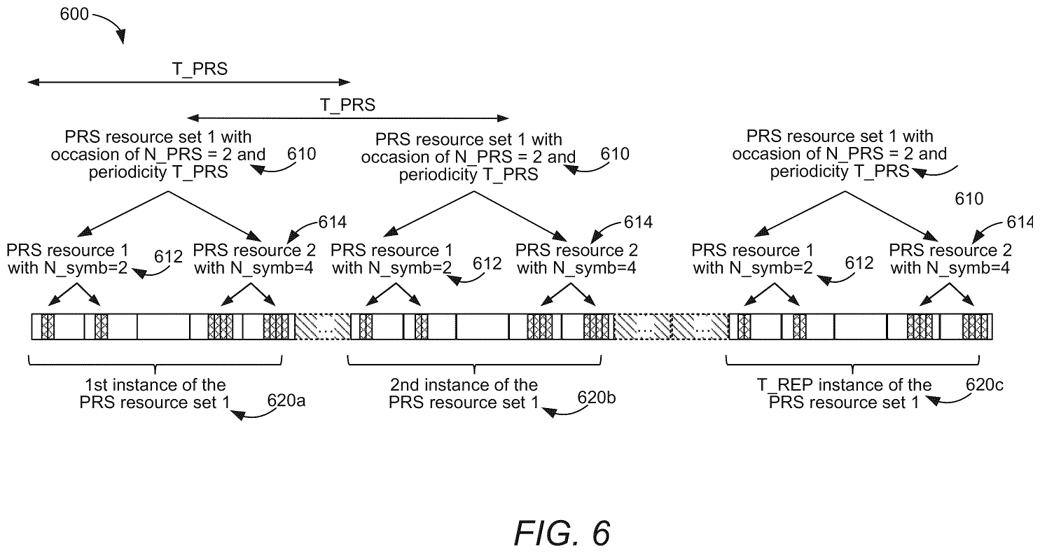

FIG. 6 is a diagram of an example PRS configuration 600 for the PRS transmissions of a given base station, according to aspects of the disclosure. In FIG. 6, time is represented horizontally, increasing from left to right. Each long rectangle represents a slot and each short (shaded) rectangle represents an OFDM symbol. In the example of FIG. 6, a PRS resource set 610 (labeled “PRS resource set 1”) includes two PRS resources, a first PRS resource 612 (labeled “PRS resource 1”) and a second PRS resource 614 (labeled “PRS resource 2”). The base station transmits PRS on the PRS resources 612 and 614 of the PRS resource set 610.

The PRS resource set 610 has an occasion length (N_PRS) of two slots and a periodicity (T_PRS) of, for example, 160 slots or 160 milliseconds (ms) (for 15 kHz subcarrier spacing). As such, both the PRS resources 612 and 614 are two consecutive slots in length and repeat every T_PRS slots, starting from the slot in which the first symbol of the respective PRS resource occurs. In the example of FIG. 6, the PRS resource 612 has a symbol length (N_symb) of two symbols, and the PRS resource 614 has a symbol length (N_symb) of four symbols. The PRS resource 612 and the PRS resource 614 may be transmitted on separate beams of the same base station.

Each instance of the PRS resource set 610, illustrated as instances 620a, 620b, and 620c, includes an occasion of length ‘2’ (i.e., N_PRS=2) for each PRS resource 612, 614 of the PRS resource set. The PRS resources 612 and 614 are repeated every T_PRS slots up to the muting sequence periodicity T_REP. As such, a bitmap of length T_REP would be needed to indicate which occasions of instances 620a, 620b, and 620c of PRS resource set 610 are muted (i.e., not transmitted).

In an aspect, there may be additional constraints on the PRS configuration 600. For example, for all PRS resources (e.g., PRS resources 612, 614) of a PRS resource set (e.g., PRS resource set 610), the base station can configure the following parameters to be the same: (a) the occasion length (N_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

The PRS signal may be used by the UE to perform a downlink (DL) reference signal time difference (RSTD) measurement on the PRS of each base station. These measurement results are then reported to the location server.

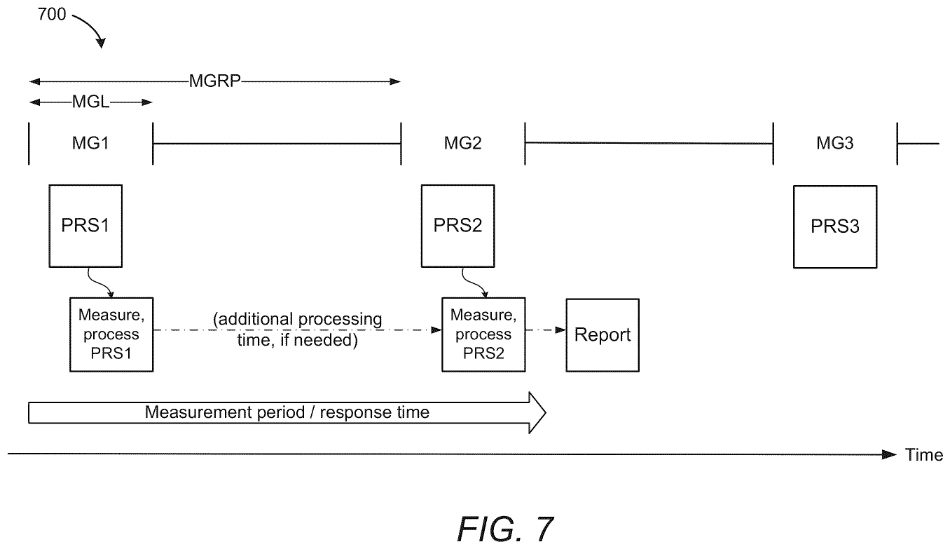

FIG. 7 illustrates an example 700 of measuring and processing PRS data during an active mode, which may also be referred to herein as a connected mode or connected state. In FIG. 7, each of the PRS occurrences, labeled PRS1, PRS2, and PRS3, is processed almost immediately by the UE, and the results are reported by the UE after the conclusion of the measurement period/response time. In connected mode, PRS processing may extend beyond the measurement gap. The measurement period length depends on a number of factors, among them the number of PRS samples to be taken. For example, T_{PRS-RSTD,i} is the measurement period for PRS RSTD measurement in i positioning frequency layer, and is calculated as specified below:

$${T}_{PRS - RSTD , i} = ( {CSSF}_{PRS , i} ⋆ {N}_{RxBeam , i} ⋆ ⌈ \frac{{N}_{PRS , i}^{slot}}{N} ⌉ ⌈ \frac{{L}_{available PRS , i}}{N} ⌉ * \\ {N}_{sample} - 1 ) * {T}_{effect , i} + {T}_{last} ,$$

where:
N_{RxBeam,i} is the UE Rx beam sweeping factor. In FR1, N_{RxBeam,i}=1; and in FR2 N_{RxBeam,i}=8.
CSSF_{PRS,i} is the carrier-specific scaling factor for the positioning frequency layer i as defined in clause 9.1.5.2 as CSSF_{within_gap,i}.
Nₛₐₘₚₗₑ is the number of PRS RSTD samples and Nₛₐₘₚₗₑ=4.
Tₗₐₛₜ is the measurement duration for the last PRS RSTD sample, including the sampling time and processing time, Tₗₐₛₜ=Tᵢ+T_{available PRS,i}.

$${T}_{effect , i} = ⌈ \frac{T}{{T}_{available \_ PRS , i}} ⌉ * {T}_{a vailable \_ PRS , i} .$$

T_{available_PRS,i}=LCM (T_{PRS,i}, MGRPᵢ), the least common multiple between T_{PRS,i} and MGRPᵢ.
L_{available PRS,i} is the time duration of available PRS in the positioning frequency layer i to be measured during T_{available_PRS,i} and is calculated in the same way as PRS duration K defined in clause 5.1.6.5 of TS 38.214. For calculation of L_{available PRS,i}, only the PRS resources unmuted and fully or partially overlapped with MG are considered.
N_{PRS,i}^{slot}, is the maximum number of DL PRS resources in positioning frequency layer i configured in a slot.
{N, T} is UE capability combination per band where N is a duration of DL PRS symbols in ms processed every T ms for a given maximum bandwidth supported by UE as specified in clause 4.2.7.2 of 3GPP TS 38.306.
N′ is UE capability for number of DL PRS resources that it can process in a slot as specified in clause 4.2.7.2 of 3GPP TS 38.306.
   If positioning frequency layer i has more than one DL PRS resource set with different PRS periodicities, the maximum PRS periodicity among DL PRS resource sets is used to derive the measurement period of that positioning frequency layer.

After a random access procedure, the UE is in an RRC CONNECTED state. The RRC protocol is used on the air interface between a UE and a base station. The major functions of the RRC protocol include connection establishment and release functions, broadcast of system information, radio bearer establishment, reconfiguration, and release, RRC connection mobility procedures, paging notification and release, and outer loop power control. In LTE, a UE may be in one of two RRC states (CONNECTED or IDLE), but in NR, a UE may be in one of three RRC states (CONNECTED, IDLE, or INACTIVE). The different RRC states have different radio resources associated with them that the UE can use when it is in a given state. Note that the different RRC states are often capitalized, as above; however, this is not necessary, and these states can also be written in lowercase.

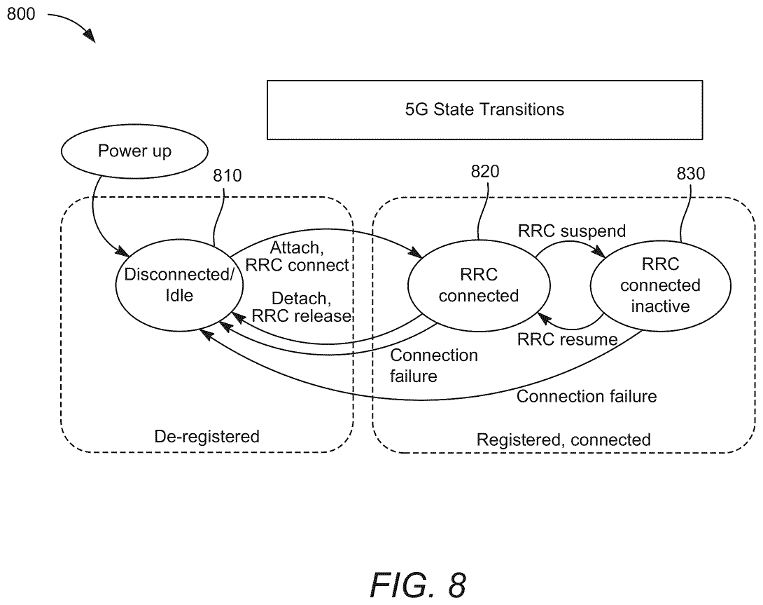

FIG. 8 is a diagram 800 of the different RRC states (also referred to as RRC modes) available in NR, according to aspects of the disclosure. When a UE is powered up, it is initially in the RRC DISCONNECTED/IDLE state 810. After a random access procedure, it moves to the RRC CONNECTED state 820. If there is no activity at the UE for a short time, it can suspend its session by moving to the RRC INACTIVE state 830. The RRC INACTIVE state may alternatively be referred to herein as the RRC_INACTIVE state, the inactive state, or the inactive mode. The UE can resume its session by performing a random access procedure to transition back to the RRC CONNECTED state 820. Thus, the UE needs to perform a random access procedure to transition to the RRC CONNECTED state 820, regardless of whether the UE is in the RRC IDLE state 810 or the RRC INACTIVE state 830.

The operations performed in the RRC IDLE state 810 include public land mobile network (PLMN) selection, broadcast of system information, cell re-selection mobility, paging for mobile terminated data (initiated and managed by the 5GC), discontinuous reception (DRX) for core network paging (configured by non-access stratum (NAS)).

The operations performed in the RRC CONNECTED state 820 include 5GC (e.g., 5GC 260) and NG-RAN (e.g., NG-RAN 220) connection establishment (both control and user planes), UE context storage at the NG-RAN and the UE, NG-RAN knowledge of the cell to which the UE belongs, transfer of unicast data to/from the UE, and network controlled mobility.

The operations performed in the RRC INACTIVE state 830 include the broadcast of system information, cell re-selection for mobility, paging (initiated by the NG-RAN), RAN-based notification area (RNA) management (by the NG-RAN), DRX for RAN paging (configured by the NG-RAN), 5GC and NG-RAN connection establishment for the UE (both control and user planes), storage of the UE context in the NG-RAN and the UE, and NG-RAN knowledge of the RNA to which the UE belongs.

Even when there is no traffic being transmitted from the network to a UE, the UE is expected to monitor every downlink subframe on the physical downlink control channel (PDCCH). This means that the UE has to be “on,” or active, all the time, even when there is no traffic, since the UE does not know exactly when the network will transmit data for it. However, being active all the time is a significant power drain for a UE.

To address this issue, a UE may implement discontinuous reception (DRX) and/or connected-mode discontinuous reception (CDRX) techniques. DRX and CDRX are mechanisms in which a UE goes into a “sleep” mode for a scheduled periods of time and “wakes up” for other periods of time. During the wake, or active, periods, the UE checks to see if there is any data coming from the network, and if there is not, goes back into sleep mode.

To implement DRX and CDRX, the UE and the network need to be synchronized. In a worst-case scenario, the network may attempt to send some data to the UE while the UE is in sleep mode, and the UE may wake up when there is no data to be received. To prevent such scenarios, the UE and the network should have a well-defined agreement about when the UE can be in sleep mode and when the UE should be awake/active. This agreement has been standardized in various technical specifications. Note that DRX includes CDRX, and thus, references to DRX refer to both DRX and CDRX, unless otherwise indicated.

The network (e.g., serving cell) can configure the UE with the DRX/CDRX timing using an RRC Connection Reconfiguration message (for CDRX) or an RRC Connection Setup message (for DRX). The network can signal the following DRX configuration parameters to the UE. (1) DRX Cycle: The duration of one ‘ON time’ plus one ‘OFF time.’ This value is not explicitly specified in RRC messages; rather, it is calculated by the subframe/slot time and “long DRX cycle start offset.” (2) ON Duration Timer: The duration of ‘ON time’ within one DRX cycle. (3) DRX Inactivity Timer: How long a UE should remain ‘ON’ after the reception of a PDCCH. When this timer is on, the UE remains in the ‘ON state,’ which may extend the ON period into the period that would be the ‘OFF’ period otherwise. (4) DRX Retransmission Timer: The maximum number of consecutive PDCCH subframes/slots a UE should remain active to wait for an incoming retransmission after the first available retransmission time. (5) Short DRX Cycle: A DRX cycle that can be implemented within the ‘OFF’ period of a long DRX cycle. (6) DRX Short Cycle Timer: The consecutive number of subframes/slots that should follow the short DRX cycle after the DRX inactivity timer has expired.

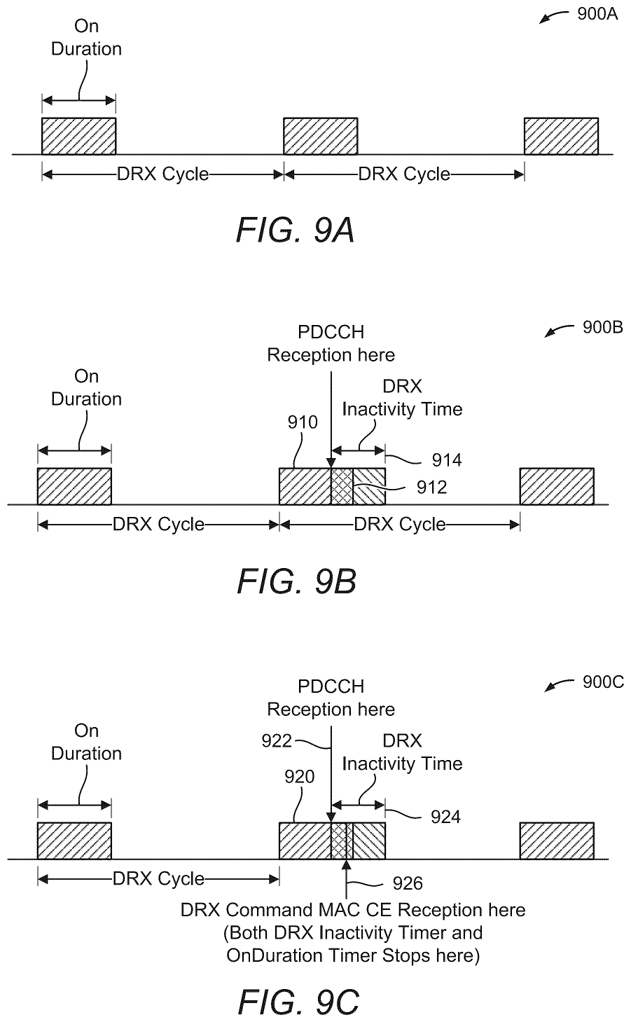

FIGS. 9A to 9C illustrate example DRX configurations, according to aspects of the disclosure. FIG. 9A illustrates an example DRX configuration 900A in which a long DRX cycle (the time from the start of one ON duration to the start of the next ON duration) is configured and no PDCCH is received during the cycle. FIG. 9B illustrates an example DRX configuration 900B in which a long DRX cycle is configured and a PDCCH is received during an ON duration 910 of the second DRX cycle illustrated. Note that the ON duration 910 ends at time 912. However, the time that the UE is awake/active (the “active time”) is extended to time 914 based on the length of the DRX inactivity timer and the time at which the PDCCH is received. Specifically, when the PDCCH is received, the UE starts the DRX inactivity timer and stays in the active state until the expiration of that timer (which is reset each time a PDCCH is received during the active time).

FIG. 9C illustrates an example DRX configuration 900C in which a long DRX cycle is configured and a PDCCH and a DRX command MAC control element (MAC-CE) are received during an ON duration 920 of the second DRX cycle illustrated. Note that the active time beginning during ON duration 920 would normally end at time 924 due to the reception of the PDCCH at time 922 and the subsequent expiration of the DRX inactivity timer at time 924, as discussed above with reference to FIG. 9B. However, in the example of FIG. 9C, the active time is shortened to time 926 based on the time at which the DRX command MAC-CE, which instructs the UE to terminate the DRX inactivity timer and the ON duration timer, is received.

In greater detail, the active time of a DRX cycle is the time during which the UE is considered to be monitoring the PDCCH. The active time may include the time during which the ON duration timer is running, the DRX inactivity timer is running, the DRX retransmission timer is running, the MAC contention resolution timer is running, a scheduling request has been sent on the PUCCH and is pending, an uplink grant for a pending HARQ retransmission can occur and there is data in the corresponding HARQ buffer, or a PDCCH indicating a new transmission addressed to the cell radio network temporary identifier (C-RNTI) of the UE has not been received after successful reception of a random access response (RAR) for the preamble not selected by the UE. And, in non-contention-based random access, after receiving the RAR, the UE should be in an active state until the PDCCH indicating new transmission addressed to the C-RNTI of the UE is received.

When a UE is in the RRC_INACTIVE state, reception of DL PRS has lower priority than reception of other DL signals or channels, such as random access messages, paging, SSB, SIB1, CORESET0, and others. Current standards, however, do not specify how a UE should handle conflicts between DL PRS and other DL signals or channels while in inactive states, nor how to handle retuning time for situations where the DL PRS signals and other DL signals or channels are allocated in a different bandwidth than the initial DL BWP, have a different SCS than the initial DL BWP, or both.

For a UE in the RRC_INACTIVE state that can support DL PRS processing inside and outside of the initial DL BWP, for DL PRS processing outside of the initial DL BWP, the SCS and/or the cyclic prefix (CP) type can be the same as or different from the initial DL BWP, but for DL PRS processing inside the initial DL BWP, the SCS and CP type of the DL PRS is the same as the initial DL BWP. Current standards, however, do not consider the potential impact of retuning time on DL PRS reception performance, or what assistance information will be needed by the UE. Moreover, current standards do not define mechanisms by which a UE can report its capability for handling DL PRS processing in RRC_INACTIVE state. In short, current standards do not specify UE behavior for reception of DL PRS in RRC_INACTIVE state.

In the RRC_INACTIVE state, the UE can perform at least the following functions: a UE-specific DRX may be configured by upper layers or by the RRC layer; a UE can control its mobility based on the network configuration; the UE can store the UE inactive access stratum (AS) context; and a RAN-based notification area can be configured by the RRC layer. Moreover, the UE: monitors short messages transmitted with a paging radio network temporary identifier (P-RNTI) over DCI; monitors a paging channel for core network (CN) paging using a 5G short temporary mobile subscriber identity (5G-S-TMSI) and for RAN paging using full inactive RNTI (I-RNTI); performs neighboring cell measurements and cell (re-)selection: performs RAN-based notification area updates periodically and when moving outside the configured RAN-based notification area; acquires system information (SI) and can send an SI request (if configured); performs logging of available measurements together with location and time for logged measurement configured UEs; and performs idle/inactive measurements for idle/inactive measurement configured UEs.

For cell (re-)selection, the UE performs both intra-frequency measurements and inter-frequency measurements. For intra-frequency measurements, the UE measures secondary synchronization signal reference signal received power (SS-RSRP) and secondary synchronization signal reference signal received quality (SS-RSRQ) at least every T_{measure,NR_Intra}, as defined in the table below:

TABLE 1
Intra-Frequency Measurement Period (3GPP TS 38.133, table 4.2.2.3-1)

| | Scaling Factor | | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|---|
| DRX cycle | (N1) | | (number of DRX | (number of DRX | (number of DRX |
| length [s] | FR1 | FR2^{Note1} | cycles) | cycles) | cycles) |
| 0.32 | 1 | 8 | 11.52 × N1 × M2 | 1.28 × N1 × M2 | 5.12 × N1 × M2 |
| | | | (36 × N1 × M2) | (4 × N1 × M2) | (16 × N1 × M2) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note1}
Applies for UE supporting power class 2&3&4. For UE supporting power class 1, N1 = 8 for all DRX cycle length.
Note 2:
M2 = 1.5 if SSB-based measurement timing configuration (SMTC) periodicity of measured intra-frequency cell >20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_{_{—}}ᵢₙₜᵣₐ is expected.

For inter-frequency measurements, the UE measures SS-RSRP and SS-RSRQ at least every K_{carrier}*T_{measure,NR_Inter}, as defined in the table below, where the parameter K_{carrier} is the number of NR inter-frequency carriers indicated by the serving cell. The parameter K_{carrier} for a UE configured with idle mode CA measurements (while T331 is running), is the combined number of NR inter-frequency carriers indicated by the serving cell and the number of NR inter-frequency carriers configured for idle mode CA measurements.

TABLE 2
Inter-Frequency Measurement Period (3GPP TS 38.133, table 4.2.2.4-1)

| DRX | Scaling Factor | | T_{detect, NR}_{_{—}}_{Inter} [s] | T_{measure, NR}_{_{—}}_{Inter} [s] | T_{evaluate, NR}_{_{—}}_{Inter} [s] |
|---|---|---|---|---|---|
| cycle | (N1) | | (number of DRX | (number of DRX | (number of DRX |
| length [s] | FR1 | FR2^{Note1} | cycles) | cycles) | cycles) |
| 0.32 | 1 | 8 | 11.52 × N1 × 1.5 | 1.28 × N1 × 1.5 | 5.12 × N1 × 1.5 |
| | | | (36 × N1 × 1.5) | (4 × N1 × 1.5) | (16 × N1 × 1.5) |
| 0.64 | | 5 | 17.92 × N1 | 1.28 × N1 | 5.12 × N1 |
| | | | (28 × N1) | (2 × N1) | (8 × N1) |
| 1.28 | | 4 | 32 × N1 | 1.28 × N1 | 6.4 × N1 |
| | | | (25 × N1) | (1 × N1) | (5 × N1) |
| 2.56 | | 3 | 58.88 × N1 | 2.56 × N1 | 7.68 × N1 |
| | | | (23 × N1) | (1 × N1) | (3 × N1) |

^{Note1}
Applies for UE supporting power class 2&3&4. For UE supporting power class 1, N1 = 8 for all DRX cycle length.

Current specifications provide for some exceptions to the reporting requirement that may apply under certain conditions, such as when the DRX cycle is short relative to the periodicity of the reference signal. For inter-frequency measurements, for example, the UE is not expected to meet the measurement requirements for an inter-frequency carrier under DRX cycle=320 ms defined in Table 4.2.2.4-1 if T_{SMTC_intra}=T_{SMTC_inter}=160 ms, where:
T_{SMTC_intra} is the periodicity of the SMTC configured for the intra-frequency carrier if no identified intra-frequency cell is in the PCI list of smtc2-LP on this intra-frequency carrier; T_{SMTC_intra} is the periodicity of the smtc2-LP configured for the intra-frequency carrier if at least one identified intra-frequency cell is in the PCI list of smtc2-LP on this intra-frequency carrier. During PSS/SSS detection, the periodicity of the SMTC configured for the intra-frequency carrier is assumed for T_{SMTC_intra}. If the actual SSB transmission periodicity is greater than the SMTC configured for the intra-frequency carrier, longer T_{detect,NR_intra} is expected.
T_{SMTC_inter} is the actual SMTC periodicity used by the inter-frequency cell being identified. During PSS/SSS detection, the periodicity of the SMTC configured for the inter-frequency carrier is assumed for T_{SMTC_inter}. If the actual SSB transmission periodicity is greater than the SMTC configured for the inter-frequency carrier, longer T_{detect, NR_inter} is expected.

SMTC occasions configured for the inter-frequency carrier occur up to 1 ms before the start or up to 1 ms after the end of the SMTC occasions configured for the intra-frequency carrier, and SMTC occasions configured for the intra-frequency carrier and for the inter-frequency carrier occur up to 1 ms before the start or up to 1 ms after the end of the paging occasion. In this case, the 1 ms buffer time on either end of the SMTC or paging occasions may be used by the UE for retuning of the RF circuitry to and from the BWP used by the SMTC or paging signals.

For paging, the UE monitors one paging occasion (PO) per DRX cycle. A PO is a set of PDCCH monitoring occasions and can consist of multiple time slots (e.g. subframe or OFDM symbol) where a paging DCI may be sent. One paging frame (PF) is one radio frame and may contain one or multiple PO(s) or starting point of a PO. The PF and PO for paging are determined by the following formulae:

SFN for the PF is determined by:

$$( SFN + {PF}_{offset} ) mod T = ( T div N ) \cdot ( {UE}_{ID mod N} )$$

Index (iₛ), indicating the index of the PO is determined by:

$${i}_{s} = floor ( {UE}_{ID} / N ) mod Ns$$

where
T is the DRX cycle of the UE (T is determined by the shortest of the UE specific DRX value(s), if configured by RRC and/or upper layers, and a default DRX value broadcast in system information. In RRC IDLE state, if UE specific DRX is not configured by upper layers, the default value is applied);
N is the number of total paging frames in T (1, 2, 4, 8, 16);
Ns is the number of paging occasions for a PF (1, 2, 4);
PF_{offset} is the offset used for PF determination; and
UE_{ID} is the 5G-S-TMSI mod 1024

When SearchSpaceId=0 is configured for pagingSearchSpace. Ns is either 1 or 2. For Ns=1, there is only one PO which starts from the first PDCCH monitoring occasion for paging in the PF. For Ns=2, PO is either in the first half frame (iₛ=0) or the second half frame (iₛ=1) of the PF.

When SearchSpaceId other than 0 is configured for pagingSearchSpace, the UE monitors the (iₛ+1)th PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0, 1, . . . , X−1, K=1, 2, . . . , S.

The PDCCH monitoring occasions for a PO can span multiple radio frames. When SearchSpaceId other than 0 is configured for paging-SearchSpace the PDCCH monitoring occasions for a PO can span multiple periods of the paging search space.

Thus, paging and cell reselections are two functions that may occur during the same DRX occasion in which it is desired to also have DL PRS measurements. Because paging and cell reselection have a higher priority than DL PRS, if a DL PRS occurs within, or too close to, a paging or cell reselection operation, the DL PRS will be ignored by the UE. This should be taken into account during DL PRS measurement in RRC_INACTIVE state.

Methods and systems for determining PRS measurement periods for UEs in RRC_INACTIVE state are herein presented. The techniques disclosed herein allow for DL PRS measurement within a DRX occasion while avoiding conflicts with paging and cell reselection and also allowing the UE to save power, e.g., by limiting the amount of time that the UE needs to spend on measuring and processing the DL PRS signals.

In some aspects, the UE measures one positioning frequency layer (PFL) at a time, just as the UE currently does in the connected state.

In some aspects, the measurement period scales with DRX_{length}. This is in contrast to the connected state, where the measurement period is a function of a measurement gap. In the RRC_INACTIVE state, measurement gaps are not defined. In some aspects, the following formulas are used to determine the measurement period for taking RSTD measurements PRSs on L number of PFLs, referred to as T_{RSTD,Total}:

$${T}_{RSTD , Total} = {\sum }_{i = 1}^{L} {T}_{RSTD , i} + ( L - 1 ) * D R {X}_{length} \qquad ( 1 )$$

$${T}_{RSTD , i} = ( K * {N}_{RxBeam , i} * ⌈ \frac{{N}_{PRS , i}^{slot}}{{N}_{i}^{′}} ⌉ * {N}_{window , i} * {N}_{sample} - 1 ) * {DRX}_{length} + {T}_{last , i} \qquad ( 2 )$$

Equation (1) defines the total amount of time taken to measure all of the PRSs on L number of PFLs, and is the sum of the measurements of the individual layers, plus an additional amount of time proportional to the number of PFLs times the length of the DRX period.

Equation (2) defines the amount of time taken to measure all of the PRSs on one PFL, and is a function of the UE's capability to process PRS signals. Thus, in some aspects, new UE capability parameters are defined, such as (Nᵢ, Tᵢ), where Nᵢ is the maximum duration of PRS that the UE can buffer (e.g., store) in its memory, assuming the maximum PRS bandwidth supported on the corresponding frequency band, and Tᵢ is the length of additional time needed to process a PRS duration of Nᵢ milliseconds, assuming the maximum PRS bandwidth supported on the corresponding frequency band, while in RRC_INACTIVE state. The PRS duration of Nᵢ ms does not necessarily have to be contiguous in time, and the UE can choose to report its buffering capability in one of two ways: by counting either the number of slots or the number of symbols occupied by PRS. In equation (2), the measurement period scales according to a scaling factor K. The value of K depends on the UE capability: for a low-capability UE, K=K_{carrier}+1. e.g., the UE is given an amount of time for measuring K_{carrier} inter-frequency NR carriers in addition to PRS (one positioning frequency layer), but for a high-capability UE, K=1, e.g., the UE does not need additional time to measure the PRS signals (because it has an independent processing engine, for example). In equation (2), N_{window,i}=the number of measurement windows required to measure all of the PRS resources in T_{PRs,i}. The UE processes at most PRS duration Nᵢ in each measurement window. In equation (2), T_{last,i}=Tᵢ+DRX_{length}. T_{last,l} is the time to process the last PRS.

In some aspects, a DL PRS measurement window of length L_{window,l} is defined for each DRX cycle. This measurement window includes time for both measurement and processing of DL PRS signals. In some aspects, the duration of L_{windows,i} is greater than or equal to Nᵢ+Tᵢ. L_{window,i} is used to limit the amount of time that the UE is awake during the DRX cycle for DL PRS measurements, which helps reduce power consumption of the UE. For example, in some aspects. L_{windows,i} may be a value that is less than or equal to 6 msecs per DRX cycle (e.g., 5 ms for measurement and 1 ms for retuning). In some aspects, this window is defined by the UE rather than by the network.

In some aspects, exceptions to the reporting requirements may apply. For example, in some aspects, the reporting requirements may not apply if the DRX_{length} is less than some multiple (e.g., 2) of the duration of time occupied by PRS signals (T_{PRS,i}), or if DRX_{length} is less than the length of the paging occasion (PO_{length})+T_{PRs,i}+Δ, where Δ accounts for inter-frequency measurement overhead (e.g., retuning). In some aspects, a reporting exception may be made when the PRS signals are too close to an SMTC occasion or a paging occasion. In some aspects, on-demand PRS may be excepted from this applicability requirement.

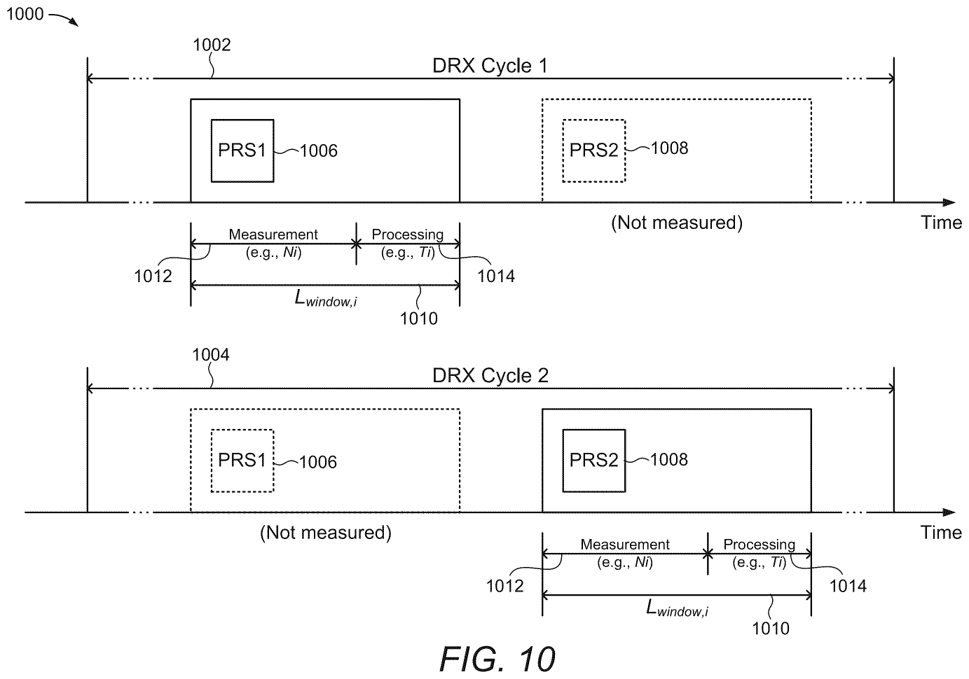

FIG. 10 illustrates an example of PRS measurement during RRC_INACTIVE state, according to aspects of the disclosure. FIG. 10 is a time and frequency graph 1000 showing two sequential DRX cycles, DRX cycle 1002 and DRX cycle 1004, of an example UE. In FIG. 10, there are two sets of PRS resources which the UE can measure: PRS1 1006 and PRS2 1008. In FIG. 10, L_{window,i} 1010 includes a measurement period 1012 with a duration which may be shorter than, longer than, or equal to time Nᵢ, and a processing period 1014 with a duration which is equal to time Tᵢ. The measurement period 1012 of each window lasts L_{windows,i}−Tᵢ. If the measurement period 1012 is longer than Nᵢ, the UE is not expected to measure/process more than Nᵢ ms per window because each window allocates only enough time (Tᵢ) to process a PRS duration of Nᵢ ms. It is noted that the measurement period 1012 may or may not be continuous in time and that the processing period 1014 starts after the PRS duration of Nᵢ has been received.

In the example shown in FIG. 10, PRS1 1006 and PRS2 1008 are relatively far apart in time. If the UE remains awake for a length of time sufficient to measure both sets of PRS resources, the UE consumes more power. Instead, in this example, the value of L_{window,i 10}10 is made long enough to measure only one set of PRS resources per DRX cycle. Thus, in FIG. 10, PRS1 1006 is measured during DRX cycle 1002 and PRS2 1008 is measured during DRX cycle 1004. During DRX cycle 1002, PRS2 1008 is not measured, and during DRX cycle 1004, PRS1 1006 is not measured. Thus, in the example shown in FIG. 10, the value of N_{window,i}=2. It is noted that even though the UE may be capable of processing both sets of PRS resources during one DRX cycle, the two sets of PRS resources may be processed in separate DRX cycles in order to reduce the UE's overall power consumption.

The working principles and exemption conditions described above may be applied by a UE without coordination with an LMF or other location server, which controls the PRS configuration of the UE. For example, in some aspects, it may be presumed by the UE that PRS measurement and reporting requirements in RRC_INACTIVE state do not apply to any PRS resources that overlap in time with paging or cell reselection occasions or that are within some guard time before or after a paging or reselection occasion. In some aspects this guard time can be preconfigured on or signaled to the UE.

However, it is beneficial for the location server to be aware of the paging occasion parameters being used by the UE, so that the location server can adjust the UE's PRS configuration to avoid collisions between the POs and PRSs. Thus, in some aspects, the UE provides PO configuration information to the location server, e.g., as part of an on-demand PRS request from the UE, or via other signaling means.

In addition, in some aspects, the UE may report to the location server the UE's PRS processing capabilities, e.g., (Nᵢ, Tᵢ), for RRC_INACTIVE state. In some aspects, the UE may define L_{window,i} to be equal to Nᵢ+Tᵢ by default. In some aspects, the location server may request a specific value of L_{window,i} to be used by the UE, e.g., up to some maximum value defined by the specifications. For example, referring again to FIG. 10, the location server may request that the UE use a value of L_{window,i} that is long enough to span both PRS1 1006 and PRS2 1008, in which case the UE will process both sets of PRS resources within the same DRX cycle. In either case, the UE processes up to Nᵢ milliseconds of PRS resources during each DRX cycle, where the PRS resources are contained within a contiguous time window of length L_{window,i}−Tᵢ.

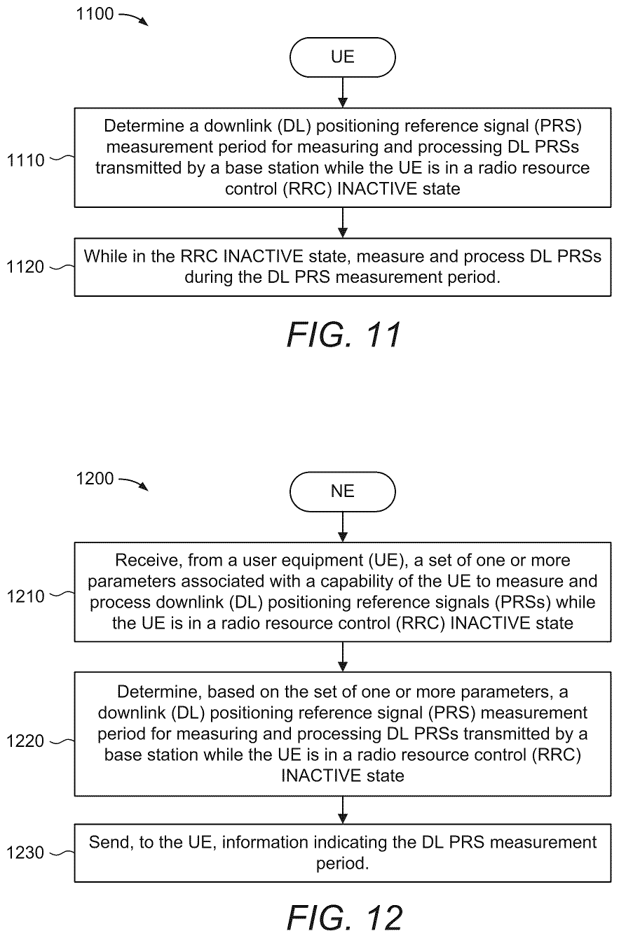

FIG. 11 is a flowchart of an example process 1100 associated with positioning reference signal measurement period for user equipment in inactive state, according to aspects of the disclosure. In some implementations, one or more process blocks of FIG. 11 may be performed by a user equipment (UE) (e.g., UE 104). In some implementations, one or more process blocks of FIG. 11 may be performed by another device or a group of devices separate from or including the UE. Additionally, or alternatively, one or more process blocks of FIG. 11 may be performed by one or more components of UE 302, such as processor(s) 332, memory 340, WWAN transceiver(s) 310, short-range wireless transceiver(s) 320, satellite signal receiver 330, sensor(s) 344, user interface 346, and positioning module(s) 342, any or all of which may be means for performing the operations of process 1100.

As shown in FIG. 11, process 1100 may include determining a downlink (DL) positioning reference signal (PRS) measurement period for measuring and processing DL PRSs transmitted by a base station while the UE is in a radio resource control (RRC) INACTIVE state (block 1110). Means for performing the operation of block 1110 may include the processor(s) 332, memory 340, or WWAN transceiver(s) 310 of the UE 302. For example, the UE 302 may determine a downlink (DL) positioning reference signal (PRS) measurement period for measuring and processing DL PRSs transmitted by a base station while the UE is in a radio resource control (RRC) INACTIVE state, using [identify component here].

As further shown in FIG. 11, process 1100 may include while in the RRC INACTIVE state, measuring and processing DL PRSs during the DL PRS measurement period (block 1120). Means for performing the operation of block 1120 may include the processor(s) 332, memory 340, or WWAN transceiver(s) 310 of the UE 302. For example, the UE 302 may determine the DL PRS measurement period using the processor(s) 332 or may receive an indication of the DL PRS measurement period via the receiver(s) 312.

In some aspects, determining the DL PRS measurement period comprises determining the DL PRS measurement period based on factors that include at least one of a length of a discontinuous reception (DRX) period, a length of a DRX ON period, a number of positioning frequency layers to be measured, a number of DL PRS resources to be measured, a scaling factor K related to a processing capability of the UE, a length of time Nᵢ during which the UE can measure DL PRS resources, a length of time Tᵢ required by the UE to process DL PRS resources that have been measured, or a number of how many DL PRS measurement windows are needed to measure all of the DL PRSs. In some aspects, the DL PRS measurement period occurs during a discontinuous reception (DRX) occasion and may extend over multiple DRX cycles.

In some aspects, process 1100 includes sending, to a location server, a set of one or more parameters describing a capability of the UE to measure and process DL PRSs while the UE is in the RRC INACTIVE state. In some aspects, the set of one or more parameters describing the capability of the UE to measure and process DL PRSs while the UE is in the RRC INACTIVE state comprises Nᵢ and Tᵢ, where Nᵢ is the maximum duration of PRS that the UE can buffer (e.g., store) in its memory, assuming the maximum PRS bandwidth supported on the corresponding frequency band, and Tᵢ is the length of additional time needed to process a PRS duration of Nᵢ milliseconds, assuming the maximum PRS bandwidth supported on the corresponding frequency band. In some aspects, determining the DL PRS measurement period comprises determining the DL PRS measurement period based at least in part on information received from a location server, such as PRS assistance data and a location request.

In some aspects, process 1100 further comprises reporting a result of a DL PRS measurement to a network entity. In some aspects, process 1100 further comprises reporting or not reporting a result of a DL PRS measurement according to a determination whether or not to report the result. In some aspects, reporting or not reporting a result of a DL PRS measurement to a network entity according to the determination comprises reporting the result if one of a first set of conditions is satisfied, not reporting the result if one of a second set of conditions is satisfied, or a combination thereof. In some aspects, not reporting the result if one of a second set of conditions is satisfied comprises not reporting the result if the DL PRS measurement occurs less than a threshold amount of time away from another type of DL transmission.

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally. or alternatively, two or more of the blocks of process 1100 may be performed in parallel.

FIG. 12 is a flowchart of an example process 1200 associated with positioning reference signal measurement period for user equipment in inactive state, according to aspects of the disclosure. In some implementations, one or more process blocks of FIG. 12 may be performed by a network entity (NE) (e.g., location server 172, LMF 270). In some implementations, one or more process blocks of FIG. 12 may be performed by another device or a group of devices separate from or including the NE. Additionally, or alternatively, one or more process blocks of FIG. 12 may be performed by one or more components of network entity 306, such as processor(s) 394, memory 396, network transceiver(s) 390, and positioning module(s) 398, any or all of which may be means for performing the operations of process 1200.

As shown in FIG. 12, process 1200 may include receiving, from a user equipment (UE), a set of one or more parameters associated with a capability of the UE to measure and process downlink (DL) positioning reference signals (PRSs) while the UE is in a radio resource control (RRC) INACTIVE state (block 1210). Means for performing the operation of block 1210 may include the processor(s) 394, memory 396, or network transceiver(s) 390 of the network entity 306. For example, the NE 306 may receive the set of one or more parameters via the network transceiver(s) 390. In some aspects, the set of one or more parameters describing the capability of the UE to measure and process DL PRSs while the UE is in the RRC INACTIVE state comprises Nᵢ and Tᵢ as defined above.

As further shown in FIG. 12, process 1200 may include determining, based on the set of one or more parameters, a downlink (DL) positioning reference signal (PRS) measurement period for measuring and processing DL PRSs transmitted by a base station while the UE is in a radio resource control (RRC) INACTIVE state (block 1220). Means for performing the operation of block 1220 may include the processor(s) 394, memory 396, or network transceiver(s) 390 of the network entity 306. For example, the NE 306 may determine the DL PRS measurement period using the processor(s) 394. In some aspects, determining the DL PRS measurement period based on the set of one or more parameters comprises calculating the DL PRS measurement period as at least a sum of Nᵢ and Tᵢ. In some aspects, process 1200 includes determining paging or cell reselection occasions for the UE, and creating or modifying a PRS configuration for the UE such that collisions between DL PRS transmissions and paging or cell reselection occasions are avoided.

As further shown in FIG. 12, process 1200 may include sending, to the UE, information indicating the DL PRS measurement period (block 1230). Means for performing the operation of block 1230 may include the processor(s) 394, memory 396, or network transceiver(s) 390 of the network entity 306. For example, the NE 306 may send the information indicating the DL PRS measurement period to the UE using the network transceiver(s) 390. In some aspects, determining paging or cell reselection occasions for the UE comprises receiving, from the UE, the information indicating paging or cell reselection occasions for the UE. In some aspects, receiving, from the UE, the information indicating paging or cell reselection occasions for the UE comprises receiving the information indicating paging or cell reselection occasions as part of an on-demand PRS request from the UE. In some aspects, this information may be provided to the UE in the form of a preferred PRS configuration that avoids collisions with paging occasions, cell re-selection measurement occasions, or both.

Process 1200 may include additional implementations, such as any single implementation or any combination of implementations described below and/or in connection with one or more other processes described elsewhere herein. Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

As will be appreciated, a technical advantage of the methods 1100 and 1200 is that they allow for DL PRS measurement within a DRX occasion while avoiding conflicts with paging and cell reselection and also allowing the UE to save power, e.g., by limiting the amount of time that the UE needs to spend on measuring and processing the DL PRS signals. In addition, efficiency would be another advantage enabled by on-demand PRS, e.g., by not transmitting PRS resources that the UE cannot measure due to collisions with other higher-priority signals.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), the method comprising: determining a downlink (DL) positioning reference signal (PRS) measurement period for measuring and processing DL PRSs transmitted by a base station while the UE is in a radio resource control (RRC) INACTIVE state; and while in the RRC INACTIVE state, measuring and processing DL PRSs during the DL PRS measurement period.

Clause 2. The method of clause 1, wherein the DL PRS measurement period occurs during at least one discontinuous reception (DRX) occasion.

Clause 3. The method of any of clauses 1 to 2, wherein determining the DL PRS measurement period comprises determining the DL PRS measurement period based on factors that include at least one of: a length of a discontinuous reception (DRX) period; a length of a DRX ON period; a number of positioning frequency layers to be measured; a number of DL PRS resources to be measured; a scaling factor K related to a processing capability of the UE; a length of time Ni defining a maximum duration of PRS that the UE can buffer assuming a maximum PRS bandwidth supported on a corresponding frequency band: a length of time Ti defining a length of time required by the UE to process a PRS duration of Ni assuming the maximum PRS bandwidth supported on the corresponding frequency band; or a number of how many DL PRS measurement windows are needed to measure all of the DL PRSs.

Clause 4. The method of any of clauses 1 to 3, further comprising sending, to a location server, a set of one or more parameters describing a capability of the UE to measure and process DL PRSs while the UE is in the RRC INACTIVE state.

Clause 5. The method of clause 4, wherein the set of one or more parameters describing the capability of the UE to measure and process DL PRSs while the UE is in the RRC INACTIVE state comprises at least one of: a length of time Ni defining a maximum duration of PRS that the UE can buffer assuming a maximum PRS bandwidth supported on a corresponding frequency band; or a length of time Ti defining a length of time required by the UE to process a PRS duration of Ni assuming the maximum PRS bandwidth supported on the corresponding frequency band.

Clause 6. The method of any of clauses 4 to 5, wherein determining the DL PRS measurement period comprises determining the DL PRS measurement period based at least in part on information received from a location server.

Clause 7. The method of clause 6, wherein determining the DL PRS measurement period based at least in part on information received from a location server comprises determining the DL PRS measurement period based at least in part on at least one of: PRS assistance data; or a location request.

Clause 8. The method of any of clauses 1 to 7, wherein measuring and processing DL PRSs during the DL PRS measurement period further comprises reporting or not reporting a result of a DL PRS measurement to a network entity, according to a determination.

Clause 9. The method of clause 8, wherein reporting or not reporting a result of a DL PRS measurement to a network entity according to the determination comprises reporting the result if one of a first set of conditions is satisfied, not reporting the result if one of a second set of conditions is satisfied, or a combination thereof.

Clause 10. The method of clause 9, wherein not reporting the result if one of a second set of conditions is satisfied comprises not reporting the result if the DL PRS measurement occurs less than a threshold amount of time away from another type of DL transmission.

Clause 11. A method of wireless communication performed by a network entity, the method comprising: receiving, from a user equipment (UE), a set of one or more parameters associated with a capability of the UE to measure and process downlink (DL) positioning reference signals (PRSs) while the UE is in a radio resource control (RRC) INACTIVE state; and determining, based on the set of one or more parameters, a downlink (DL) positioning reference signal (PRS) measurement period for measuring and processing DL PRSs transmitted by a base station while the UE is in a radio resource control (RRC) INACTIVE state; and sending, to the UE, information for determining the DL PRS measurement period.

Clause 12. The method of clause 11, wherein the set of one or more parameters describing the capability of the UE to measure and process DL PRSs while the UE is in the RRC INACTIVE state comprises at least one of: a length of time Ni defining a maximum duration of PRS that the UE can buffer assuming a maximum PRS bandwidth supported on a corresponding frequency band; or a length of time Ti defining a length of time required by the UE to process a PRS duration of Ni assuming the maximum PRS bandwidth supported on the corresponding frequency band.

Clause 13. The method of clause 12, wherein determining the DL PRS measurement period based on the set of one or more parameters comprises calculating a DL PRS measurement window as at least a sum of Ni and Ti.

Clause 14. The method of any of clauses 11 to 13, wherein sending the information for determining the DL PRS measurement period comprises sending at least one of: PRS assistance data; or a location request.

Clause 15. The method of any of clauses 11 to 14, further comprising: determining paging or cell reselection occasions for the UE; and creating or modifying a PRS configuration for the UE such that collisions between DL PRS transmissions and paging or cell reselection occasions are avoided.

Clause 16. The method of clause 15, wherein determining paging or cell reselection occasions for the UE comprises receiving, from the UE, the information indicating paging or cell reselection occasions for the UE.

Clause 17. The method of clause 16, wherein receiving, from the UE, the information indicating paging or cell reselection occasions for the UE comprises at least one of: receiving the information indicating paging or cell reselection occasions as part of an on-demand PRS request from the UE; or receiving a preferred PRS configuration that avoids collisions with paging occasions, cell re-selection measurement occasions, or both.

Clause 18. A user equipment (UE), comprising: a memory; at least one transceiver; and at least one processor communicatively coupled to the memory and the at least one transceiver, the at least one processor configured to: determine a downlink (DL) positioning reference signal (PRS) measurement period for measuring and processing DL PRSs transmitted by a base station while the UE is in a radio resource control (RRC) INACTIVE state; and while in the RRC INACTIVE state, measure and process DL PRSs during the DL PRS measurement period.

Clause 19. The UE of clause 18, wherein the DL PRS measurement period occurs during at least one discontinuous reception (DRX) occasion.

Clause 20. The UE of any of clauses 18 to 19, wherein, to determine the DL PRS measurement period, the at least one processor is configured to determine the DL PRS measurement period based on factors that include at least one of: a length of a discontinuous reception (DRX) period; a length of a DRX ON period; a number of positioning frequency layers to be measured; a number of DL PRS resources to be measured; a scaling factor K related to a processing capability of the UE; a length of time Ni defining a maximum duration of PRS that the UE can buffer assuming a maximum PRS bandwidth supported on a corresponding frequency band; a length of time Ti defining a length of time required by the UE to process a PRS duration of Ni assuming the maximum PRS bandwidth supported on the corresponding frequency band; or a number of how many DL PRS measurement windows are needed to measure all of the DL PRSs.

Clause 21. The UE of any of clauses 18 to 20, wherein the at least one processor is further configured to send, via the at least one transceiver, to a location server, a set of one or more parameters describing a capability of the UE to measure and process DL PRSs while the UE is in the RRC INACTIVE state.

Clause 22. The UE of clause 21, wherein the set of one or more parameters describing the capability of the UE to measure and process DL PRSs while the UE is in the RRC INACTIVE state comprises at least one of: a length of time Ni defining a maximum duration of PRS that the UE can buffer assuming a maximum PRS bandwidth supported on a corresponding frequency band; or a length of time Ti defining a length of time required by the UE to process a PRS duration of Ni assuming the maximum PRS bandwidth supported on the corresponding frequency band.

Clause 23. The UE of any of clauses 21 to 22, wherein, to determine the DL PRS measurement period, the at least one processor is configured to determine the DL PRS measurement period based at least in part on information received from a location server.

Clause 24. The UE of any of clauses 18 to 23, wherein, to measure and processing DL PRSs during the DL PRS measurement period, the at least one processor is configured to report or not report a result of a DL PRS measurement to a network entity, according to a determination.

Clause 25. The UE of clause 24, wherein, to report or not report a result of a DL PRS measurement to a network entity according to the determination, the at least one processor is configured to report the result if one of a first set of conditions is satisfied, not reporting the result if one of a second set of conditions is satisfied, or a combination thereof.

Clause 26. The UE of clause 25, wherein not reporting the result if one of a second set of conditions is satisfied comprises not reporting the result if the DL PRS measurement occurs less than a threshold amount of time away from another type of DL transmission.

Clause 27. A network entity, comprising: a memory; at least one transceiver; and at least one processor communicatively coupled to the memory and the at least one transceiver, the at least one processor configured to: receive, via the at least one transceiver, from a user equipment (UE), a set of one or more parameters associated with a capability of the UE to measure and process downlink (DL) positioning reference signals (PRSs) while the UE is in a radio resource control (RRC) INACTIVE state; and determine, based on the set of one or more parameters, a downlink (DL) positioning reference signal (PRS) measurement period for measuring and processing DL PRSs transmitted by a base station while the UE is in a radio resource control (RRC) INACTIVE state; and send, via the at least one transceiver, to the UE, information for determining the DL PRS measurement period.

Clause 28. The network entity of clause 27, wherein the set of one or more parameters describing the capability of the UE to measure and process DL PRSs while the UE is in the RRC INACTIVE state comprises at least one of: a length of time Ni defining a maximum duration of PRS that the UE can buffer assuming a maximum PRS bandwidth supported on a corresponding frequency band; or a length of time Ti defining a length of time required by the UE to process a PRS duration of Ni assuming the maximum PRS bandwidth supported on the corresponding frequency band.

Clause 29. The network entity of clause 28, wherein, to determine the DL PRS measurement period based on the set of one or more parameters, the at least one processor is configured to calculate a DL PRS measurement window as at least a sum of Ni and Ti.

Clause 30. The network entity of any of clauses 27 to 29, wherein the at least one processor is further configured to: determine paging or cell reselection occasions for the UE; and create or modify a PRS configuration for the UE such that collisions between DL PRS transmissions and paging or cell reselection occasions are avoided.

Clause 31. The network entity of clause 30, wherein, to determine paging or cell reselection occasions for the UE, the at least one processor is configured to receive, from the UE, the information indicating paging or cell reselection occasions for the UE.

Clause 32. The network entity of clause 31, wherein, to receive, from the UE, the information indicating paging or cell reselection occasions for the UE, the at least one processor is configured to at least one of: receive the information indicating paging or cell reselection occasions as part of an on-demand PRS request from the UE; or receive a preferred PRS configuration that avoids collisions with paging occasions, cell re-selection measurement occasions, or both.

Clause 33. An apparatus comprising a memory, a transceiver, and a processor communicatively coupled to the memory and the transceiver, the memory, the transceiver, and the processor configured to perform a method according to any of clauses 1 to 17.

Clause 34. An apparatus comprising means for performing a method according to any of clauses 1 to 17.

Clause 35. A non-transitory computer-readable medium storing computer-executable instructions, the computer-executable comprising at least one instruction for causing a computer or processor to perform a method according to any of clauses 1 to 17.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a user equipment (UE), the method comprising:
determining a downlink (DL) positioning reference signal (PRS) measurement period for measuring and processing DL PRSs transmitted by a base station while the UE is in a radio resource control (RRC) INACTIVE state; and
while in the RRC INACTIVE state, measuring and processing DL PRSs during the DL PRS measurement period.

2. The method of claim 1, wherein the DL PRS measurement period occurs during at least one discontinuous reception (DRX) occasion.

3. The method of claim 1, wherein determining the DL PRS measurement period comprises determining the DL PRS measurement period based on factors that include at least one of:
a length of a discontinuous reception (DRX) period;
a length of a DRX ON period;
a number of positioning frequency layers to be measured;
a number of DL PRS resources to be measured;
a scaling factor K related to a processing capability of the UE;
a length of time Nᵢ defining a maximum duration of PRS that the UE can buffer assuming a maximum PRS bandwidth supported on a corresponding frequency band;
a length of time Tᵢ defining a length of time required by the UE to process a PRS duration of Nᵢ assuming the maximum PRS bandwidth supported on the corresponding frequency band; or
a number of how many DL PRS measurement windows are needed to measure all of the DL PRSs.

4. The method of claim 1, further comprising sending, to a location server, a set of one or more parameters describing a capability of the UE to measure and process DL PRSs while the UE is in the RRC INACTIVE state.

5. The method of claim 4, wherein the set of one or more parameters describing the capability of the UE to measure and process DL PRSs while the UE is in the RRC INACTIVE state comprises at least one of:
a length of time Nᵢ defining a maximum duration of PRS that the UE can buffer assuming a maximum PRS bandwidth supported on a corresponding frequency band; or
a length of time Tᵢ defining a length of time required by the UE to process a PRS duration of Nᵢ assuming the maximum PRS bandwidth supported on the corresponding frequency band.

6. The method of claim 4, wherein determining the DL PRS measurement period comprises determining the DL PRS measurement period based at least in part on information received from the location server.

7. The method of claim 6, wherein determining the DL PRS measurement period based at least in part on information received from the location server comprises determining the DL PRS measurement period based at least in part on at least one of:
PRS assistance data; or
a location request.

8. The method of claim 1, further comprising reporting or not reporting a result of a DL PRS measurement to a network entity, according to a determination.

9. The method of claim 8, wherein reporting or not reporting a result of a DL PRS measurement to a network entity according to the determination comprises reporting the result if one of a first set of conditions is satisfied, not reporting the result if one of a second set of conditions is satisfied, or a combination thereof.

10. The method of claim 9, wherein not reporting the result if one of a second set of conditions is satisfied comprises not reporting the result if the DL PRS measurement occurs less than a threshold amount of time away from another type of DL transmission.

11. A method of wireless communication performed by a network entity, the method comprising:
receiving, from a user equipment (UE), a set of one or more parameters associated with a capability of the UE to measure and process downlink (DL) positioning reference signals (PRSs) while the UE is in a radio resource control (RRC) INACTIVE state; and
determining, based on the set of one or more parameters, a downlink (DL) positioning reference signal (PRS) measurement period for measuring and processing DL PRSs transmitted by a base station while the UE is in a radio resource control (RRC) INACTIVE state; and
sending, to the UE, information for determining the DL PRS measurement period.

12. The method of claim 11, wherein the set of one or more parameters describing the capability of the UE to measure and process DL PRSs while the UE is in the RRC INACTIVE state comprises at least one of:
a length of time Nᵢ defining a maximum duration of PRS that the UE can buffer assuming a maximum PRS bandwidth supported on a corresponding frequency band; or
a length of time Tᵢ defining a length of time required by the UE to process a PRS duration of Nᵢ assuming the maximum PRS bandwidth supported on the corresponding frequency band.

13. The method of claim 12, wherein determining the DL PRS measurement period based on the set of one or more parameters comprises calculating a DL PRS measurement window as at least a sum of Nᵢ and Tᵢ.

14. The method of claim 11, wherein sending the information for determining the DL PRS measurement period comprises sending at least one of:
PRS assistance data; or
a location request.

15. The method of claim 11, further comprising:
determining paging or cell reselection occasions for the UE; and
creating or modifying a PRS configuration for the UE such that collisions between DL PRS transmissions and paging or cell reselection occasions are avoided.

16. The method of claim 15, wherein determining paging or cell reselection occasions for the UE comprises receiving, from the UE, information indicating paging or cell reselection occasions for the UE.

17. The method of claim 16, wherein receiving, from the UE, the information indicating paging or cell reselection occasions for the UE comprises at least one of:
receiving the information indicating paging or cell reselection occasions as part of an on-demand PRS request from the UE; or
receiving a preferred PRS configuration that avoids collisions with paging occasions, cell re-selection measurement occasions, or both.

18. A user equipment (UE), comprising:
a memory;
at least one transceiver; and
at least one processor communicatively coupled to the memory and the at least one transceiver, the at least one processor configured to:
determine a downlink (DL) positioning reference signal (PRS) measurement period for measuring and processing DL PRSs transmitted by a base station while the UE is in a radio resource control (RRC) INACTIVE state; and
while in the RRC INACTIVE state, measure and process DL PRSs during the DL PRS measurement period.

19. The UE of claim 18, wherein the DL PRS measurement period occurs during at least one discontinuous reception (DRX) occasion.

20. The UE of claim 18, wherein, to determine the DL PRS measurement period, the at least one processor is configured to determine the DL PRS measurement period based on factors that include at least one of:
a length of a discontinuous reception (DRX) period;
a length of a DRX ON period;
a number of positioning frequency layers to be measured;
a number of DL PRS resources to be measured;
a scaling factor K related to a processing capability of the UE;
a length of time Nᵢ defining a maximum duration of PRS that the UE can buffer assuming a maximum PRS bandwidth supported on a corresponding frequency band;
a length of time Tᵢ defining a length of time required by the UE to process a PRS duration of Nᵢ assuming the maximum PRS bandwidth supported on the corresponding frequency band; or
a number of how many DL PRS measurement windows are needed to measure all of the DL PRSs.

21. The UE of claim 18, wherein the at least one processor is further configured to send, via the at least one transceiver, to a location server, a set of one or more parameters describing a capability of the UE to measure and process DL PRSs while the UE is in the RRC INACTIVE state.

22. The UE of claim 21, wherein the set of one or more parameters describing the capability of the UE to measure and process DL PRSs while the UE is in the RRC INACTIVE state comprises at least one of:
a length of time Nᵢ defining a maximum duration of PRS that the UE can buffer assuming a maximum PRS bandwidth supported on a corresponding frequency band; or
a length of time Tᵢ defining a length of time required by the UE to process a PRS duration of Nᵢ assuming the maximum PRS bandwidth supported on the corresponding frequency band.

23. The UE of claim 21, wherein, to determine the DL PRS measurement period, the at least one processor is configured to determine the DL PRS measurement period based at least in part on information received from a location server.

24. The UE of claim 18, wherein, to measure and processing DL PRSs during the DL PRS measurement period, the at least one processor is configured to report or not report a result of a DL PRS measurement to a network entity, according to a determination.

25. A network entity, comprising:
a memory;
at least one transceiver; and
at least one processor communicatively coupled to the memory and the at least one transceiver, the at least one processor configured to:
receive, via the at least one transceiver, from a user equipment (UE), a set of one or more parameters associated with a capability of the UE to measure and process downlink (DL) positioning reference signals (PRSs) while the UE is in a radio resource control (RRC) INACTIVE state; and
determine, based on the set of one or more parameters, a downlink (DL) positioning reference signal (PRS) measurement period for measuring and processing DL PRSs transmitted by a base station while the UE is in a radio resource control (RRC) INACTIVE state; and
send, via the at least one transceiver, to the UE, information for determining the DL PRS measurement period.

26. The network entity of claim 25, wherein the set of one or more parameters describing the capability of the UE to measure and process DL PRSs while the UE is in the RRC INACTIVE state comprises at least one of:
a length of time Nᵢ defining a maximum duration of PRS that the UE can buffer assuming a maximum PRS bandwidth supported on a corresponding frequency band; or
a length of time Tᵢ defining a length of time required by the UE to process a PRS duration of Nᵢ assuming the maximum PRS bandwidth supported on the corresponding frequency band.

27. The network entity of claim 26, wherein, to determine the DL PRS measurement period based on the set of one or more parameters, the at least one processor is configured to calculate a DL PRS measurement window as at least a sum of Nᵢ and Tᵢ.

28. The network entity of claim 25, wherein the at least one processor is further configured to:
determine paging or cell reselection occasions for the UE; and
create or modify a PRS configuration for the UE such that collisions between DL PRS transmissions and paging or cell reselection occasions are avoided.

29. The network entity of claim 28, wherein, to determine paging or cell reselection occasions for the UE, the at least one processor is configured to receive, from the UE, the information indicating paging or cell reselection occasions for the UE.

30. The network entity of claim 29, wherein, to receive, from the UE, the information indicating paging or cell reselection occasions for the UE, the at least one processor is configured to at least one of:
receive the information indicating paging or cell reselection occasions as part of an on-demand PRS request from the UE; or
receive a preferred PRS configuration that avoids collisions with paging occasions, cell re-selection measurement occasions, or both.
